(19) United States
(12) Patent Application Publication
(10) Pub. No.: US 2024/0404183 A1
(43) Pub. Date: Dec. 5, 2024

(54) IMAGE PROCESSING APPARATUS, IMAGE PROCESSING METHOD, AND PROGRAM

(71) Applicant: FUJIFILM Corporation, Tokyo (JP)

(72) Inventor: Yasuhiko KANEKO, Kanagawa (JP)

(73) Assignee: FUJIFILM Corporation, Tokyo (JP)

(21) Appl. No.: 18/801,847

(22) Filed: Aug. 13, 2024

Related U.S. Application Data
(63) Continuation of application No. PCT/JP2022/041771, filed on Nov. 9, 2022.

(30) Foreign Application Priority Data
Mar. 29, 2022 (JP) 2022-053389

(51) Int. Cl. G06T 15/20; G06T 7/62; G06T 7/70; G06T 15/00

(52) U.S. Cl. CPC G06T 15/205; G06T 7/62; G06T 7/70; G06T 15/005

(57) ABSTRACT

An image processing apparatus includes a processor, in which the processor is configured to: acquire a plurality of three-dimensional coordinates for specifying positions of a plurality of pixels included in a three-dimensional image showing a target object in a real space, and a plurality of two-dimensional coordinates for specifying positions corresponding to the plurality of pixels in a screen on which the three-dimensional image is rendered; acquire unit length information indicating a relationship between a first unit length of a three-dimensional coordinate system defining the three-dimensional coordinates, and a second unit length of the real space; generate an object of which the second unit length is specifiable, based on the plurality of three-dimensional coordinates, the plurality of two-dimensional coordinates, and the unit length information; and output a first image in which the object and the three-dimensional image are shown in a comparable manner.

This application is a continuation application of International Application No. PCT/JP2022/041771, filed Nov. 9, 2022, the disclosure of which is incorporated herein by reference in its entirety. Further, this application claims priority under 35 USC 119 from Japanese Patent Application No. 2022-053389 filed Mar. 29, 2022, the disclosure of which is incorporated by reference herein.

### BACKGROUND OF THE INVENTION

### 1. Field of the Invention

The technology of the present disclosure relates to an image processing apparatus, an image processing method, and a program.

### 2. Description of the Related Art

JP2020-150405A discloses an image processing apparatus comprising a subject designation unit, a designation position acquisition unit, a change detection unit, an indicator image generation unit, and a display processing unit. The subject designation unit designates two points of a subject in a captured image. The designation position acquisition unit acquires three-dimensional position information related to the two points. The change detection unit detects a change in a state of the image processing apparatus. The indicator image generation unit generates an indicator image corresponding to a length and a change between the two points based on the three-dimensional position information and the change. The display processing unit acquires a processed image by superimposing the indicator image on the captured image.

JP2012-105048A discloses a three-dimensional view image display apparatus that displays a three-dimensional view image composed of a right eye image and a left eye image which are obtained by imaging a subject and have a parallax therebetween, in a three-dimensional viewable manner. The three-dimensional view image display apparatus comprises a cursor display unit that displays a three-dimensional cursor displayed with scale on the three-dimensional view image at a position specified by an input unit capable of inputting a three-dimensional position.

JP2009-015730A discloses an image display system with a three-dimensional measurer display function that displays a camera parameter designation display image generated by capturing a panoramic image of an imaging location in a designated imaging direction and a designated angle of view on a screen, and displays a three-dimensional measurer on the camera designation display image. The image display system with a three-dimensional measurer display function includes a three-dimensional space memory, and a three-dimensional measurer superimposed image display unit. The three-dimensional space memory stores a three-dimensional measurer that is formed by dividing left and right side surfaces and a bottom surface with a mesh, and in which a bottom surface width, a height of the side surface, and a length of the three-dimensional measurer are defined. The three-dimensional measurer superimposed image display unit three-dimensionally displays a portion of an inside of the three-dimensional measurer of a three-dimensional measurer storage unit in a case of being viewed in any direction on the camera parameter designation display image in a superimposed manner.

JP1998-170227A (JP-H10-170227A) discloses a display device comprising at least one imaging unit that images a subject, in which a plurality of captured images having overlapping visual fields and captured from different viewpoints are combined to display a three-dimensional image. The display device includes a measurer parameter calculation unit, a measurer image generation unit, and an image combining unit. The measurer parameter calculation unit calculates a magnification and a parallax of a measurer that serve as a reference for a scale of a subject according to a parallax of the subject among a plurality of captured images. The measurer image generation unit generates a measurer image based on the magnification and the parallax of the measurer calculated by the measurer parameter calculation unit. The image combining unit combines the measurer images generated by the measurer image generation unit in the three-dimensional image.

### SUMMARY OF THE INVENTION

One embodiment according to the technology of the present disclosure provides an image processing apparatus, an image processing method, and a program that can allow a user or the like to understand a size of a target object in a real space.

A first aspect according to the technology of the present disclosure relates to an image processing apparatus comprising: a processor, in which the processor is configured to: acquire a plurality of three-dimensional coordinates for specifying positions of a plurality of pixels included in a three-dimensional image showing a target object in a real space, and a plurality of two-dimensional coordinates for specifying positions corresponding to the plurality of pixels in a screen on which the three-dimensional image is rendered; acquire unit length information indicating a relationship between a first unit length of a three-dimensional coordinate system defining the three-dimensional coordinates, and a second unit length of the real space; generate an object of which the second unit length is specifiable, based on the plurality of three-dimensional coordinates, the plurality of two-dimensional coordinates, and the unit length information; and output a first image in which the object and the three-dimensional image are shown in a comparable manner.

A second aspect according to the technology of the present disclosure relates to the image processing apparatus according to the first aspect, in which the three-dimensional image is an image generated based on a plurality of two-dimensional images obtained by imaging the target object from a plurality of imaging positions in the real space.

A third aspect according to the technology of the present disclosure relates to the image processing apparatus according to the second aspect, in which the unit length information is information generated based on a distance between imaging positions adjacent to each other among the plurality of imaging positions.

A fourth aspect according to the technology of the present disclosure relates to the image processing apparatus according to the third aspect, in which the distance is a distance obtained by a positioning unit.

A fifth aspect according to the technology of the present disclosure relates to the image processing apparatus according to the second aspect, in which the second unit length is a length related to a subject image included in at least one two-dimensional image among the plurality of two-dimensional images.

A sixth aspect according to the technology of the present disclosure relates to the image processing apparatus according to any one of the first to fifth aspects, in which the object is an image generated based on designated two-dimensional coordinates among the plurality of two-dimensional coordinates.

A seventh aspect according to the technology of the present disclosure relates to the image processing apparatus according to any one of the first to sixth aspects, in which the object is an image including a figure and a numerical value indicating a length related to the figure.

An eighth aspect according to the technology of the present disclosure relates to the image processing apparatus according to any one of the first to seventh aspects, in which the processor is configured to: change a first viewpoint for observing the three-dimensional image through the screen in response to a given first instruction; and change a second viewpoint for observing the object through the screen according to the first viewpoint.

A ninth aspect according to the technology of the present disclosure relates to the image processing apparatus according to any one of the first to eighth aspects, in which the processor is configured to change a third viewpoint for observing the object through the screen in response to a given second instruction.

A tenth aspect according to the technology of the present disclosure relates to the image processing apparatus according to any one of the first to ninth aspects, in which the object includes an image showing a body existing in the real space.

An eleventh aspect according to the technology of the present disclosure relates to an image processing method comprising: acquiring a plurality of three-dimensional coordinates for specifying positions of a plurality of pixels included in a three-dimensional image showing a target object in a real space, and a plurality of two-dimensional coordinates for specifying positions corresponding to the plurality of pixels in a screen on which the three-dimensional image is rendered; acquiring unit length information indicating a relationship between a first unit length of a three-dimensional coordinate system defining the three-dimensional coordinates, and a second unit length of the real space; generating an object of which the second unit length is specifiable, based on the plurality of three-dimensional coordinates, the plurality of two-dimensional coordinates, and the unit length information; and outputting a first image in which the object and the three-dimensional image are shown in a comparable manner.

A fourteenth aspect according to the technology of the present disclosure relates to a program causing a computer to execute a process comprising: acquiring a plurality of three-dimensional coordinates for specifying positions of a plurality of pixels included in a three-dimensional image showing a target object in a real space, and a plurality of two-dimensional coordinates for specifying positions corresponding to the plurality of pixels in a screen on which the three-dimensional image is rendered; acquiring unit length information indicating a relationship between a first unit length of a three-dimensional coordinate system defining the three-dimensional coordinates, and a second unit length of the real space; generating an object of which the second unit length is specifiable, based on the plurality of three-dimensional coordinates, the plurality of two-dimensional coordinates, and the unit length information; and outputting a first image in which the object and the three-dimensional image are shown in a comparable manner.

### BRIEF DESCRIPTION OF THE DRAWINGS

FIG. 1 is a perspective view showing an example of an inspection system according to the present embodiment.

FIG. 2 is a block diagram showing an example of an inspection support apparatus according to the present embodiment.

FIG. 3 is a block diagram showing an example of an imaging apparatus according to the present embodiment.

FIG. 4 is a block diagram showing an example of a functional configuration for implementing inspection support information generation processing according to the present embodiment.

FIG. 5 is a block diagram showing an example of data transmitted from the imaging apparatus according to the present embodiment to the inspection support apparatus.

FIG. 6 is a block diagram showing an example of operations of an acquisition unit, a three-dimensional image information generation unit, and a unit length information generation unit according to the present embodiment.

FIG. 7 is a block diagram showing an example of operations of the three-dimensional image information generation unit, the unit length information generation unit, and an inspection support information generation unit according to the present embodiment.

FIG. 8 is a block diagram showing an example of a functional configuration for implementing inspection support processing according to the present embodiment.

FIG. 9 is a block diagram showing an example of operations of a rendering unit, an instruction determination unit, an instruction acquisition unit, an object generation unit, and a composite image output unit according to the present embodiment.

FIG. 10 is a block diagram showing an example of an operation of the object generation unit that executes first object generation processing according to the present embodiment.

FIG. 11 is a block diagram showing an example of an operation of the object generation unit that executes second object generation processing according to the present embodiment.

FIG. 12 is a block diagram showing an example of operations of the instruction acquisition unit and the composite image output unit according to the present embodiment.

FIG. 13 is a block diagram showing an example of the operations of the instruction acquisition unit, the object generation unit, and the composite image output unit according to the present embodiment.

FIG. 14 is a block diagram showing an example of the operations of the instruction acquisition unit and the composite image output unit according to the present embodiment.

FIG. 15 is a flowchart showing an example of a flow of the inspection support information generation processing according to the present embodiment.

FIG. 16 is a flowchart showing an example of a flow of the inspection support processing according to the present embodiment.

FIG. 17 is a flowchart showing an example of a flow of the first object generation processing according to the present embodiment.

FIG. 18 is a flowchart showing an example of a flow of the second object generation processing according to the present embodiment.

FIG. 19 is a screen view showing a first modification example of an object according to the present embodiment.

FIG. 20 is a screen view showing a second modification example of the object according to the present embodiment.

FIG. 21 is a screen view showing a third modification example of the object according to the present embodiment.

FIG. 22 is a block diagram showing a modification example of the operation of the unit length information generation unit according to the present embodiment.

### DESCRIPTION OF THE PREFERRED EMBODIMENTS

An example of embodiments of an image processing apparatus, an image processing method, and a program according to the technology of the present disclosure will be hereinafter described with reference to the accompanying drawings.

First, the terms used in the following description will be described.

CPU is an abbreviation for “central processing unit”. GPU is an abbreviation for “graphics processing unit”. HDD is an abbreviation for “hard disk drive”. SSD is an abbreviation for “solid-state drive”. RAM is an abbreviation for “random-access memory”. SRAM is an abbreviation for “static random-access memory”. DRAM is an abbreviation for “dynamic random-access memory”. EL is an abbreviation for “electroluminescence”. RAM is an abbreviation for “random-access memory”. CMOS is an abbreviation for “complementary metal-oxide-semiconductor”. GNSS is an abbreviation for “global navigation satellite system”. GPS is an abbreviation for “global positioning system”. SfM is an abbreviation for “structure from motion”. MVS is an abbreviation for “multi-view stereo”. TPU is an abbreviation for “tensor processing unit”. USB is an abbreviation for “Universal Serial Bus”. ASIC is an abbreviation for “application-specific integrated circuit”. FPGA is an abbreviation for “field-programmable gate array”. PLD is an abbreviation for “programmable logic device”. SoC is an abbreviation for “system-on-a-chip”. IC is an abbreviation for “integrated circuit”.

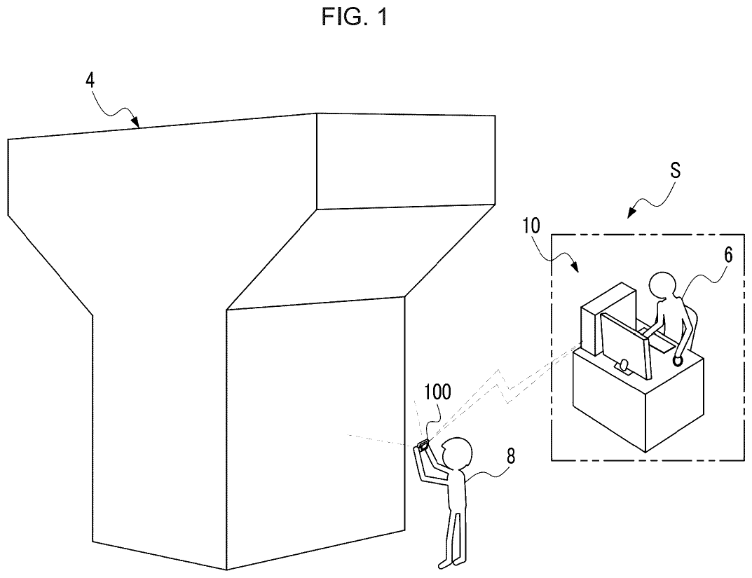

As an example, as shown in FIG. 1, an inspection system S comprises an inspection support apparatus 10 and an imaging apparatus 100. The inspection system S is a system for inspecting a target object 4 in a real space. The target object 4 is an example of a “target object” according to the technology of the present disclosure.

As an example, the target object 4 is a bridge pier made of reinforced concrete. Here, examples of the target object 4 include the bridge pier, but the target object 4 may be a road facility other than the bridge pier. Examples of the road facility include a road surface, a tunnel, a guardrail, a traffic signal, and/or a windbreak fence. The target object 4 may be a social infrastructure (for example, airport facility, port facility, water storage facility, gas facility, medical facility, firefighting facility, and/or educational facility) other than the road facility, or may be a private possession. In addition, the target object 4 may be a land (for example, a public land and/or a private land). The bridge pier shown as the target object 4 may be a bridge pier made of a material other than the reinforced concrete. In the present embodiment, the inspection refers to, for example, an inspection of a state of the target object 4. For example, the inspection system S inspects the presence or absence of damage of the target object 4 and/or a degree of damage.

The inspection support apparatus 10 is an example of an “image processing apparatus” according to the technology of the present disclosure. The inspection support apparatus 10 is, for example, a desktop personal computer. Here, the desktop personal computer is shown as the inspection support apparatus 10, but this is merely an example, and a laptop personal computer may be used. In addition, the inspection support apparatus 10 is not limited to the personal computer and may be a server. The server may be a mainframe used on-premises together with the inspection support apparatus 10, or may be an external server implemented by cloud computing. Further, the server may be an external server implemented by network computing such as fog computing, edge computing, or grid computing. The inspection support apparatus 10 is communicably connected to the imaging apparatus 100. The inspection support apparatus 10 is used by an inspector 6. The inspection support apparatus 10 may be used at a site in which the target object 4 is installed, or may be used at a place different from the site in which the target object 4 is installed.

The imaging apparatus 100 is, for example, a lens-interchangeable digital camera. Here, although a lens-interchangeable digital camera is shown as the imaging apparatus 100, this is merely an example, and a digital camera built into various electronic apparatuses such as a smart device and a wearable terminal may be used. Further, the imaging apparatus 100 may be an eyeglass-type eyewear terminal or a head mount display terminal to be mounted on a head. The imaging apparatus 100 is used by a person in charge of imaging 8.

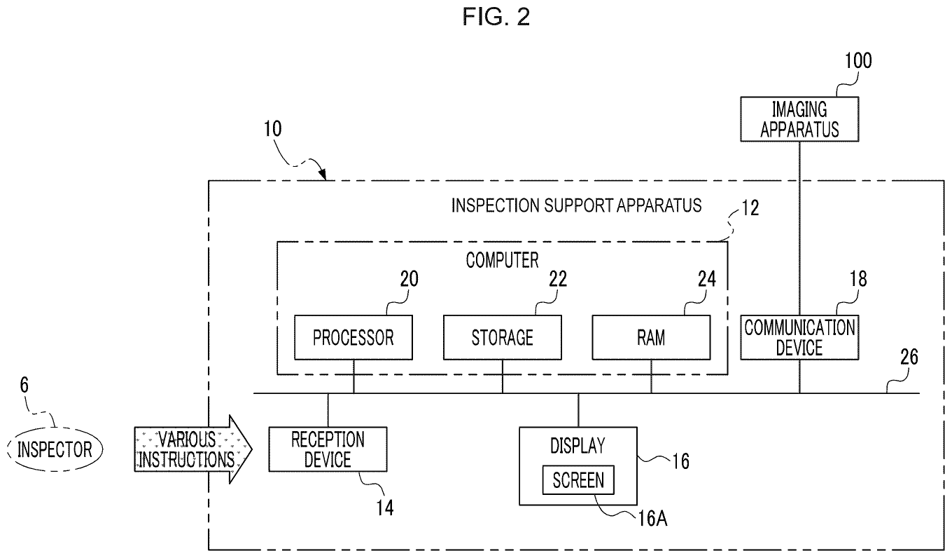

As shown in FIG. 2 as an example, the inspection support apparatus 10 comprises a computer 12, a reception device 14, a display 16, and a communication device 18.

The computer 12 is an example of a “computer” according to the technology of the present disclosure. The computer 12 comprises a processor 20, a storage 22, and a RAM 24. The processor 20 is an example of a “processor” according to the technology of the present disclosure. The processor 20, the storage 22, the RAM 24, the reception device 14, the display 16, and the communication device 18 are connected to a bus 26.

The processor 20 includes, for example, a CPU, and controls the entire inspection support apparatus 10. Here, the example is described in which the processor 20 includes the CPU, but this is merely an example. For example, the processor 20 may include a CPU and a GPU. In this case, for example, the GPU operates under control of the CPU and is responsible for executing image processing.

The storage 22 is a nonvolatile storage device that stores various programs, various parameters, and the like. Examples of the storage 22 include an HDD and an SSD. It should be noted that the HDD and the SSD are merely examples, and a flash memory, a magnetoresistive memory, and/or a ferroelectric memory may be used instead of the HDD and/or the SSD or together with the HDD and/or the SSD.

The RAM 24 is a memory that transitorily stores information, and is used as a work memory by the processor 20. Examples of the RAM 24 include a DRAM and/or an SRAM.

The reception device 14 includes a keyboard, a mouse, a touch panel, and the like (all of which are not shown), and receives various instructions from the inspector 6. The display 16 includes a screen 16A. The screen 16A is an example of a “screen” according to the technology of the present disclosure. The display 16 displays various types of information (for example, an image and text) on the screen 16A under the control of the processor 20. Examples of the display 16 include an EL display (for example, an organic EL display or an inorganic EL display). It should be noted that the display 16 is not limited to the EL display, and another type of display, such as a liquid-crystal display, may be used.

The communication device 18 is communicably connected to the imaging apparatus 100. Here, the communication device 18 is connected to the imaging apparatus 100 in a wirelessly communicable manner through a predetermined wireless communication standard. Examples of the predetermined wireless communication standard include Wi-Fi (registered trademark) and Bluetooth (registered trademark). The communication device 18 controls the exchange of the information between the inspection support apparatus 10. For example, the communication device 18 transmits the information in response to a request from the processor 20 to the imaging apparatus 100. In addition, the communication device 18 receives the information transmitted from the imaging apparatus 100, and outputs the received information to the processor 20 via the bus 26. It should be noted that the communication device 18 may be connected to the imaging apparatus 100 in a communicable manner through a wire.

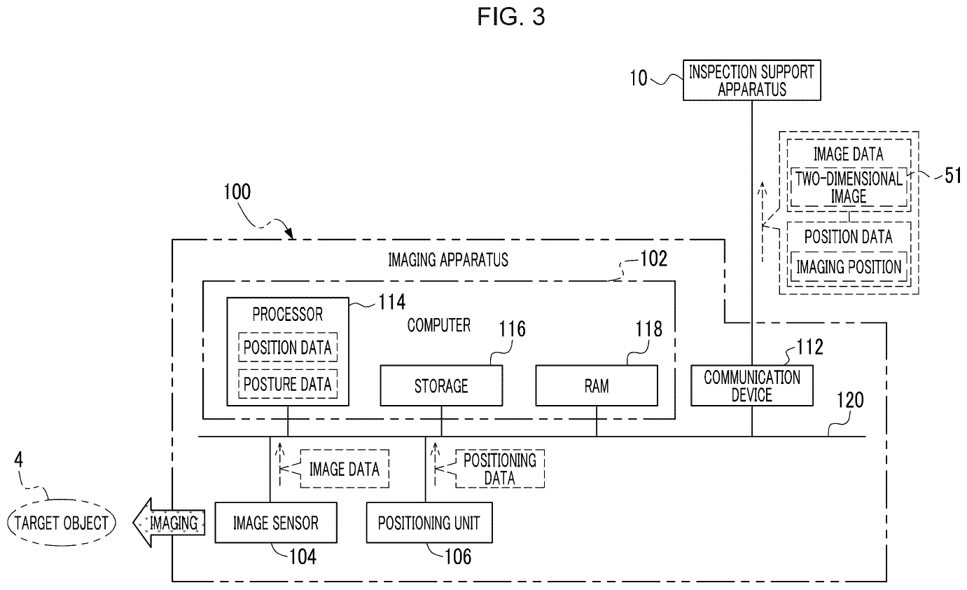

As an example, as shown in FIG. 3, the imaging apparatus 100 comprises a computer 102, an image sensor 104, a positioning unit 106, and a communication device 112.

The computer 102 comprises a processor 114, a storage 116, and a RAM 118. The processor 114, the storage 116, the RAM 118, the image sensor 104, the positioning unit 106, and the communication device 112 are connected to a bus 120. The processor 114, the storage 116, and the RAM 118 are implemented by, for example, the same hardware as the processor 20, the storage 22, and the RAM 24 provided in the inspection support apparatus 10.

The image sensor 104 is, for example, a CMOS image sensor. It should be noted that, here, the CMOS image sensor is shown as the image sensor 104, but the technology of the present disclosure is not limited to this, and another image sensor may be applied. The image sensor 104 images a subject (for example, the target object 4), and outputs image data obtained by the imaging.

The positioning unit 106 is a device that detects a position of the imaging apparatus 100. The position of the imaging apparatus 100 is detected by using, for example, a global navigation satellite system (GNSS) (for example, a GPS). The positioning unit 106 includes a GNSS receiver (not shown). The GNSS receiver receives, for example, radio waves transmitted from a plurality of satellites. The positioning unit 106 detects the position of the imaging apparatus 100 based on the radio waves received by the GNSS receiver, and outputs positioning data (for example, data indicating the latitude, the longitude, and the altitude) according to the detected position.

The processor 114 acquires the position of the imaging apparatus 100 based on the positioning data, and generates position data indicating the acquired position. Hereinafter, the position of the imaging apparatus 100 will be referred to as an “imaging position”. The imaging position acquired based on the positioning data is an imaging position in an absolute coordinate system.

It should be noted that, instead of the positioning data, an acceleration sensor (not shown) may be used, and the imaging position may be acquired based on acceleration data from the acceleration sensor. The imaging position acquired based on the acceleration data is an imaging position in a relative coordinate system.

The communication device 112 is communicably connected to the inspection support apparatus 10. The communication device 112 is implemented by using, for example, the same hardware as the communication device 18 provided in the inspection support apparatus 10.

The imaging apparatus 100 transmits the image data and the position data to the inspection support apparatus 10. The image data is data indicating a two-dimensional image 51 obtained by imaging the target object 4 via the imaging apparatus 100. The position data is data indicating the imaging position in a case in which the imaging apparatus 100 performs the imaging, and is associated with the image data.

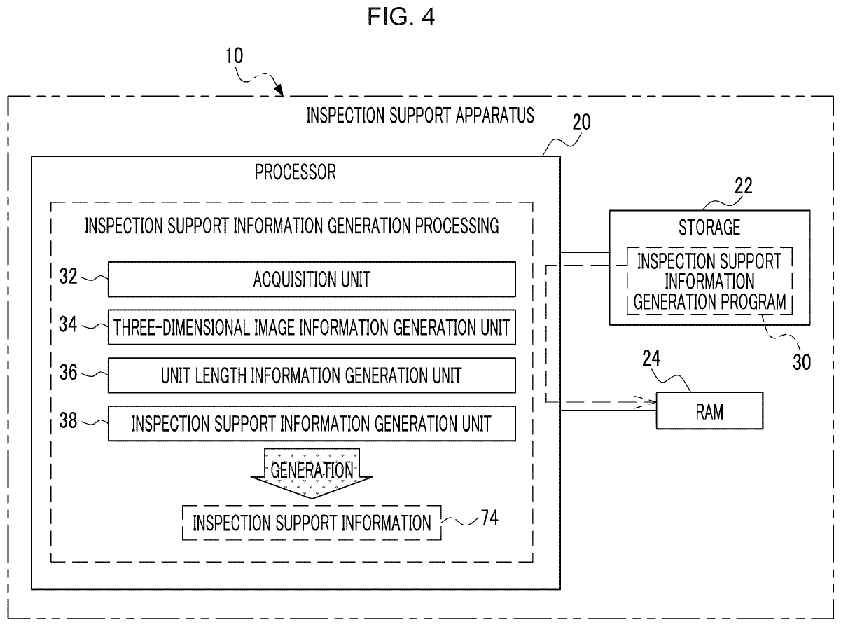

As shown in FIG. 4 as an example, the storage 22 of the inspection support apparatus 10 stores an inspection support information generation program 30. The processor 20 of the inspection support apparatus 10 reads out the inspection support information generation program 30 from the storage 22, and executes the readout inspection support information generation program 30 on the RAM 24. The processor 20 performs inspection support information generation processing for generating inspection support information 74 according to the inspection support information generation program 30 executed on the RAM 24.

The inspection support information generation processing is implemented by the processor 20 operating as an acquisition unit 32, a three-dimensional image information generation unit 34, a unit length information generation unit 36, and an inspection support information generation unit 38 according to the inspection support information generation program 30.

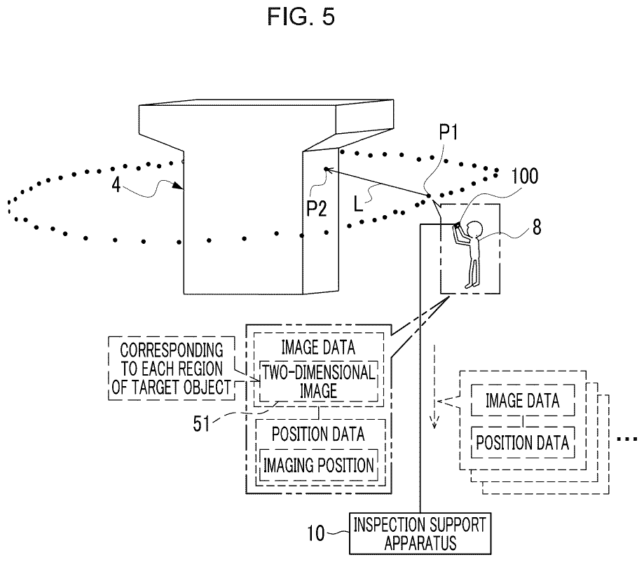

As an example, as shown in FIG. 5, a plurality of points P1 located in a circumferential direction of the target object 4 indicate the imaging positions of the imaging apparatus 100. The person in charge of imaging 8 images the target object 4 via the imaging apparatus 100 from the plurality of imaging positions in the circumferential direction of the target object 4 while moving around the periphery of the target object 4. As an example, the person in charge of imaging 8 images different regions in the target object 4 from each imaging position via the imaging apparatus 100. By imaging different regions in the target object 4 from each imaging position via the imaging apparatus 100, the entire target object 4 including a plurality of regions is imaged.

The imaging position (that is, the point P1) corresponding to each two-dimensional image 51 obtained by being captured by the imaging apparatus 100 corresponds to a starting point of a visual line L focused on the target object 4, and the imaging posture corresponding to each two-dimensional image 51 corresponds to a direction of the visual line L focused on the target object 4. A point P2 at which the target object 4 and the visual line L intersect each other corresponds to a viewpoint in a case in which the target object 4 is viewed along the visual line L. The target object 4 is imaged by the imaging apparatus 100 from each imaging position, whereby the two-dimensional image 51 corresponding to each viewpoint is obtained. Each two-dimensional image 51 is an image corresponding to each region of the target object 4.

It should be noted that, here, although the example is shown in which the person in charge of imaging 8 images the target object 4 via the imaging apparatus 100 from each imaging position while moving around the periphery of the target object 4, the target object 4 may be imaged by the imaging apparatus 100 from each imaging position in a case in which the imaging apparatus 100 is mounted in a mobile object and the mobile object moves around the periphery of the target object 4. In addition, the mobile object may be, for example, a drone, a gondola, a truck, a high-altitude work vehicle, an automatic guided vehicle, or another vehicle.

The imaging apparatus 100 associates the image data indicating the two-dimensional image 51 obtained by being captured from each imaging position with the position data indicating the imaging position in a case in which the imaging is performed. The imaging apparatus 100 transmits each image data and the position data associated with each image data to the inspection support apparatus 10.

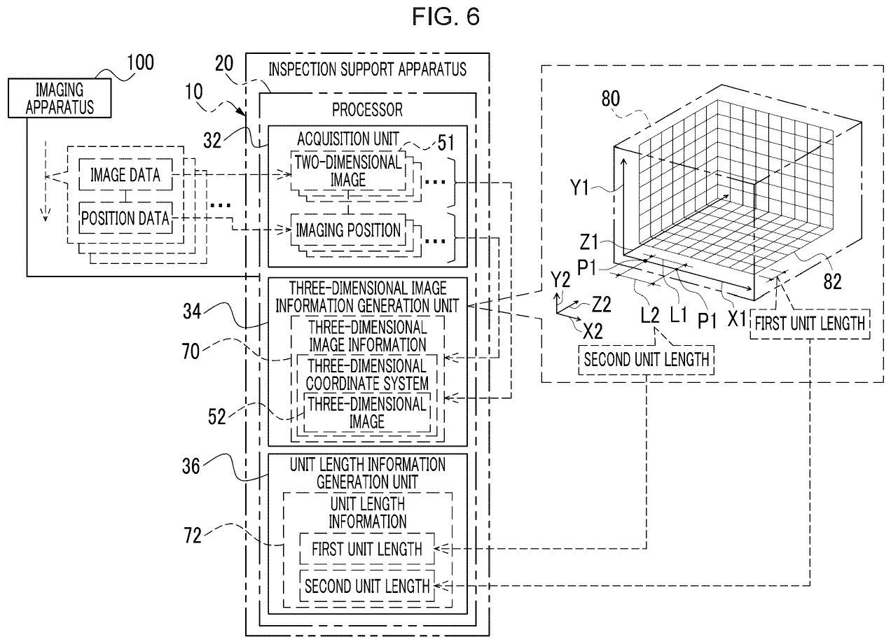

As shown in FIG. 6 as an example, the acquisition unit 32 acquires the two-dimensional image 51 based on each image data received by the inspection support apparatus 10. In addition, the acquisition unit 32 acquires the imaging position corresponding to each two-dimensional image 51 based on each position data received by the inspection support apparatus 10.

The three-dimensional image information generation unit 34 generates three-dimensional image information 70 based on the plurality of two-dimensional images 51 and the plurality of imaging positions which are acquired by the acquisition unit 32. The three-dimensional image information 70 is image information indicating the three-dimensional image 52 defined by a three-dimensional coordinate system.

The three-dimensional coordinate system is a relative coordinate system defined by the plurality of imaging positions. That is, the three-dimensional coordinate system is a coordinate system on a three-dimensional virtual space 80 that is set independently of the real space defined by a world coordinate system, which is the absolute coordinate system. An axis X1, an axis Y1, and an axis Z1 indicate three coordinate axes in the three-dimensional coordinate system, and an axis X2, an axis Y2, and an axis Z2 indicate three coordinate axes in the world coordinate system. The three-dimensional coordinates are an example of “three-dimensional coordinates” according to the technology of the present disclosure.

The three-dimensional image 52 is an image showing the target object 4 (see FIG. 5), and is an image generated based on the plurality of two-dimensional images 51. Examples of the image processing technique of generating the three-dimensional image 52 based on the plurality of two-dimensional images 51 include SfM, MVS, Epipolar geometry, and stereo matching processing. The plurality of three-dimensional coordinates for specifying the positions of the plurality of pixels included in the three-dimensional image 52 are coordinates in the three-dimensional coordinate system. The pixel is an example of a “pixel” according to the technology of the present disclosure.

An interval among a plurality of grid lines 82 set on each coordinate axis of the three-dimensional coordinate system corresponds to a distance between centers of pixels adjacent to each other in a direction of each coordinate axis among the plurality of pixels. Hereinafter, a length of the interval of the grid lines 82 will be referred to as a “first unit length”. The first unit length is a unit length of the three-dimensional coordinate system.

The three-dimensional coordinates of each imaging position (that is, the point P1) are defined by each of the coordinates of the three-dimensional coordinate system and the coordinates of the world coordinate system. Hereinafter, the distance between the imaging positions adjacent to each other defined by the coordinates of the three-dimensional coordinate system will be referred to as a “relative distance L1”, and the distance between the imaging positions adjacent to each other defined by the coordinates of the world coordinate system will be referred to as an “absolute distance L2”.

The relative distance L1 is a distance represented by the first unit length, and the absolute distance L2 is a distance represented by a second unit length set in the real space. The absolute distance L2 is a distance obtained by the positioning unit 106 (see FIG. 3). That is, each imaging position is derived based on each position data output from the positioning unit 106, and the absolute distance L2 that is the distance between the imaging positions adjacent to each other is derived based on each imaging position. The absolute distance L2 is an example of a “distance between imaging positions” according to the technology of the present disclosure.

The unit length information generation unit 36 generates unit length information 72 indicating a relationship between the first unit length and the second unit length. Specifically, the unit length information generation unit 36 acquires the relative distance L1 from the three-dimensional coordinate system included in the three-dimensional image information 70 generated by the three-dimensional image information generation unit 34. The unit length information generation unit 36 acquires the absolute distance L2 corresponding to the relative distance L1 from the plurality of imaging positions acquired by the acquisition unit 32. Then, the unit length information generation unit 36 generates the unit length information 72 indicating the relationship between the first unit length and the second unit length, based on the relative distance L1 and the absolute distance L2.

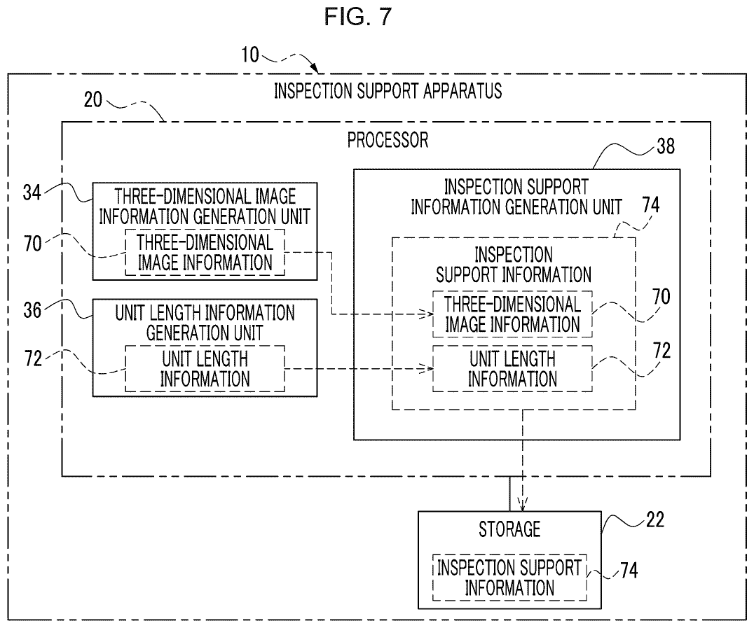

As shown in FIG. 7 as an example, the inspection support information generation unit 38 generates the inspection support information 74 including the three-dimensional image information 70 generated by the three-dimensional image information generation unit 34, and the unit length information 72 generated by the unit length information generation unit 36. The inspection support information 74 is stored in the storage 22.

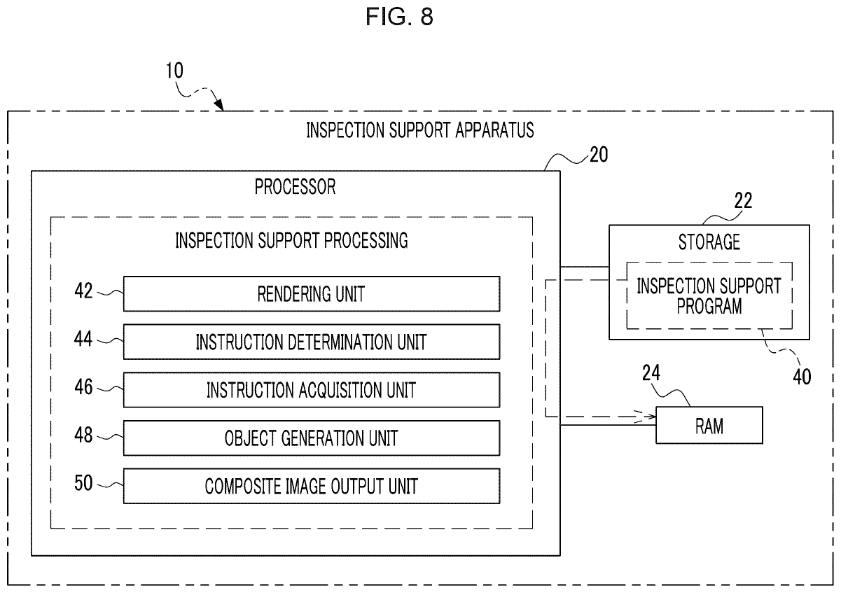

As an example, as shown in FIG. 8, the storage 22 of the inspection support apparatus 10 stores an inspection support program 40. The inspection support program 40 is an example of a “program” according to the technology of the present disclosure. The processor 20 reads out the inspection support program 40 from the storage 22, and executes the readout inspection support program 40 on the RAM 24. The processor 20 performs the inspection support processing for supporting the inspection performed by the inspector 6 (see FIG. 1) according to the inspection support program 40 executed on the RAM 24.

The inspection support processing is implemented by the processor 20 operating as a rendering unit 42, an instruction determination unit 44, an instruction acquisition unit 46, an object generation unit 48, and a composite image output unit 50 according to the inspection support program 40.

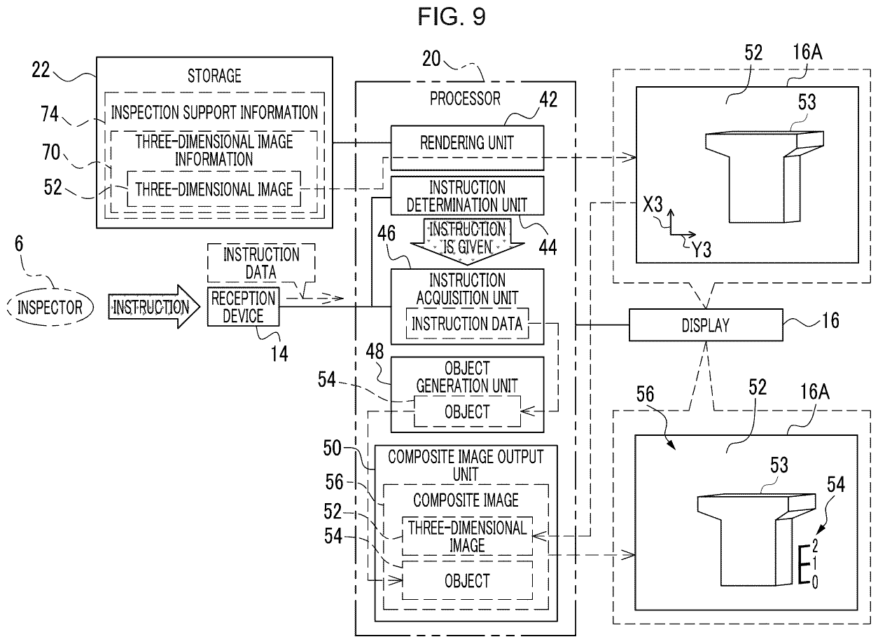

As shown in FIG. 9 as an example, the rendering unit 42 renders the three-dimensional image 52 on the screen 16A based on the plurality of pixels in the three-dimensional image 52 included in the inspection support information 74. The three-dimensional image 52 rendered on the screen 16A includes a target object image 53 corresponding to the target object 4 (see FIG. 5). The positions corresponding to the plurality of pixels in the screen 16A on which the three-dimensional image 52 is rendered are specified by the plurality of two-dimensional coordinates. The plurality of two-dimensional coordinates are coordinates in a two-dimensional coordinate system set on the screen 16A. An axis X3 and an axis Y3 represent two coordinate axes in the two-dimensional coordinate system.

The inspector 6 gives an instruction to display an object 54 to the reception device 14. A first example of the instruction to display the object 54 is an instruction to designate a start point and an end point of the object 54. In addition, a second example of the instruction to display the object 54 is an instruction to designate the start point of the object 54, a direction from the start point to the end point of the object 54 (that is, an orientation of the object 54), and a length from the start point to the end point of the object 54.

Examples of the instruction given to the reception device 14 include an instruction given by clicking the mouse, an instruction given by dragging the mouse, an instruction given by dragging and dropping the mouse, and an instruction given by inputting to the keyboard. In a case in which the instruction to display the object 54 on the screen 16A is received from the inspector 6, the reception device 14 outputs instruction data including the instruction from the inspector 6 to the processor 20.

The instruction determination unit 44 determines whether the instruction data is input to the processor 20. In a case in which the instruction determination unit 44 determines that the instruction data is input to the processor 20, the instruction acquisition unit 46 acquires the instruction data.

The object generation unit 48 executes object generation processing. The object generation processing is processing for generating the object 54 based on the instruction data acquired by the instruction acquisition unit 46. The object 54 is an example of an “object” according to the technology of the present disclosure. Details of the object generation unit 48 will be described later.

The composite image output unit 50 generates a composite image 56 by combining the three-dimensional image 52 with the object 54 generated by the object generation unit 48. The composite image output unit 50 renders the composite image 56 on the screen 16A. Consequently, the composite image 56 in which the object 54 and the three-dimensional image 52 are shown in a comparable manner is displayed on the screen 16A of the display 16. The composite image 56 is an example of a “first image” according to the technology of the present disclosure.

Subsequently, details of the object generation unit 48 and the object 54 will be described.

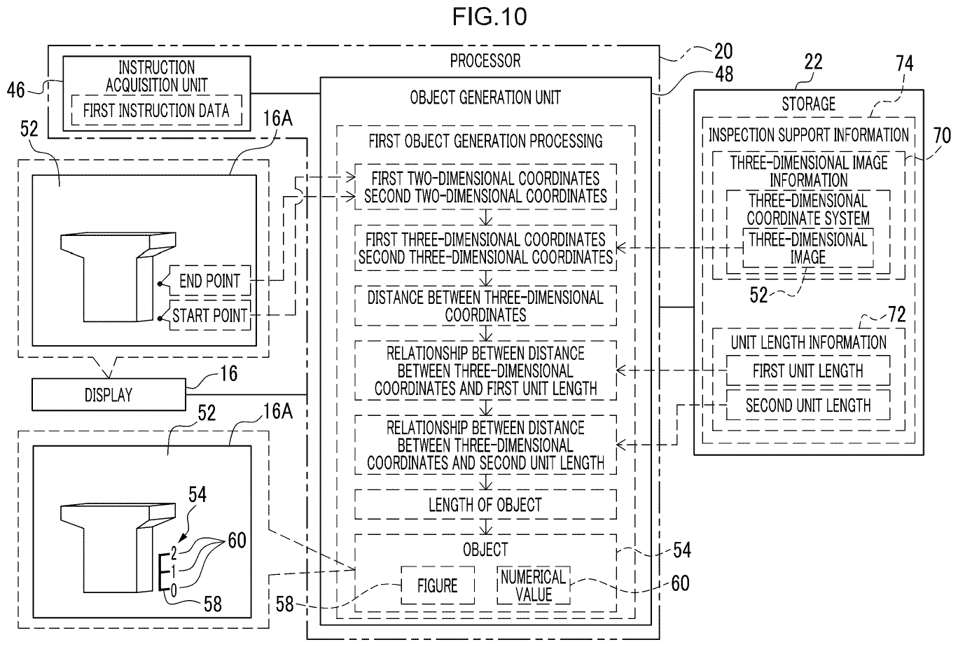

As an example, FIG. 10 shows a case in which the instruction data (hereinafter, referred to as “first instruction data”) including the instruction to designate the start point and the end point of the object 54 is acquired by the instruction acquisition unit 46. The instruction to designate the start point of the object 54 is, specifically, an instruction to designate a position corresponding to the start point of the object 54 among the positions corresponding to the plurality of pixels in the screen 16A on which the three-dimensional image 52 is rendered. In addition, the instruction to designate the end point of the object 54 is, specifically, an instruction to designate a position corresponding to the end point of the object 54 among the positions corresponding to the plurality of pixels in the screen 16A on which the three-dimensional image 52 is rendered.

In a case in which the first instruction data is acquired by the instruction acquisition unit 46, the object generation unit 48 executes first object generation processing in the object generation processing.

In the first object generation processing, the object generation unit 48 acquires first two-dimensional coordinates corresponding to the start point of the object 54 and second two-dimensional coordinates corresponding to the end point of the object 54, based on the plurality of pixels in the screen 16A on which the three-dimensional image 52 is rendered.

Next, the object generation unit 48 acquires first three-dimensional coordinates corresponding to the first two-dimensional coordinates and second three-dimensional coordinates corresponding to the second two-dimensional coordinates, based on the plurality of pixels in the three-dimensional image 52 included in the inspection support information 74.

Next, the object generation unit 48 derives a distance between the first three-dimensional coordinates and the second three-dimensional coordinates (hereinafter, referred to as a “distance between the three-dimensional coordinates”).

Next, the object generation unit 48 acquires a relationship between the distance between the three-dimensional coordinates and the first unit length based on the unit length information 72 included in the inspection support information 74.

Next, the object generation unit 48 derives a relationship between the distance between the three-dimensional coordinates and the second unit length from the relationship between the distance between the three-dimensional coordinates and the first unit length, based on the unit length information 72 included in the inspection support information 74.

Next, the object generation unit 48 derives a length of the object 54 in a case in which it is assumed that the object 54 is disposed in the real space, based on the relationship between the distance between the three-dimensional coordinates and the second unit length.

Next, the object generation unit 48 generates the object 54, which is an image including a FIG. 58 extending between the first three-dimensional coordinates and the second three-dimensional coordinates, and a numerical value 60 based on the length of the object 54.

The FIG. 58 may be any figure. In the example shown in FIG. 10, as the FIG. 58, a figure resembling a “ruler” is included in the object 54. In addition, the numerical value 60 may be any numerical value as long as the numerical value indicates a length related to the FIG. 58. In the example shown in FIG. 10, a first numerical value (for example, “0”) indicating a base point of the length, a second numerical value (for example, “1”) indicating a position of a scale attached to the FIG. 58, and a third numerical value (for example, “2”) indicating a length of the FIG. 58 are included in the object 54 as the numerical value 60. The second unit length of the object 54 is specified by the object 54 including the numerical value 60. The numerical value 60 may include, for example, a unit (for example, meters or the like) of the length of the object 54.

It should be noted that, in the first object generation processing, the object 54 is generated in response to the instruction to designate the start point and the end point of the object 54 (that is, the two points of the object 54), but the object 54 may be generated in response to an instruction to designate a plurality of points of the object 54.

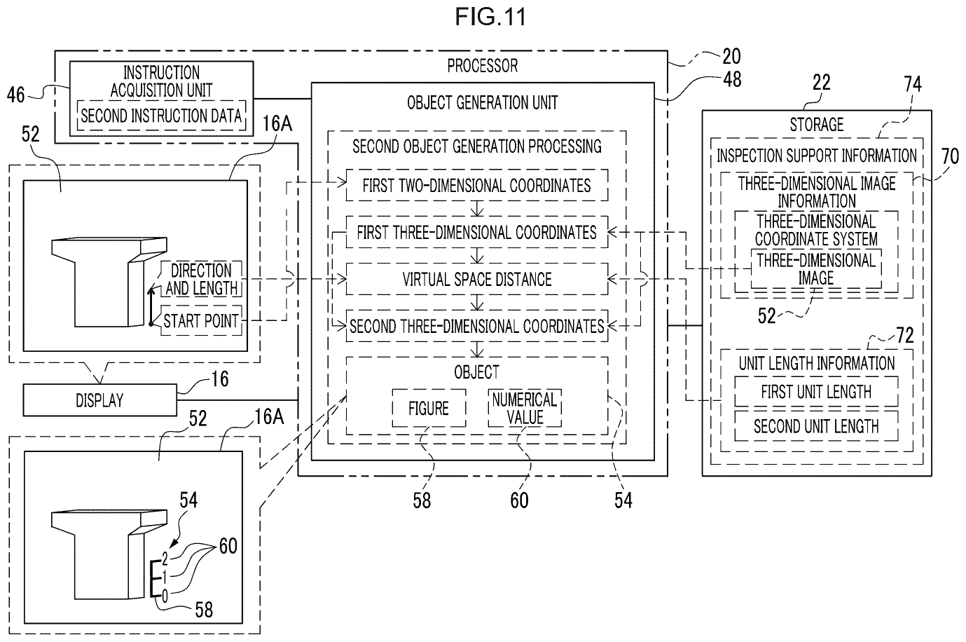

As an example, FIG. 11 shows a case in which the instruction data (hereinafter, referred to as “second instruction data”) including the instruction to designate the start point of the object 54, the direction from the start point to the end point of the object 54, and the length of the object 54 is acquired by the instruction acquisition unit 46.

The instruction to designate the direction from the start point to the end point of the object 54 is, for example, the instruction to designate the orientation of the object 54. The instruction to designate the length of the object 54 is, for example, the instruction to designate the length from the start point to the end point of the object 54.

In a case in which the second instruction data is acquired by the instruction acquisition unit 46, the object generation unit 48 executes second object generation processing in the object generation processing.

In the second object generation processing, the object generation unit 48 acquires the first two-dimensional coordinates corresponding to the start point of the object 54, based on the plurality of pixels in the screen 16A on which the three-dimensional image 52 is rendered.

Then, the object generation unit 48 acquires the first three-dimensional coordinates corresponding to the first two-dimensional coordinates based on the plurality of pixels in the three-dimensional image 52 included in the inspection support information 74.

Then, the object generation unit 48 derives a distance (hereinafter, referred to as a “virtual space distance”) in the three-dimensional virtual space 80 (see FIG. 6) corresponding to the direction from the start point to the end point of the object 54 and the length of the object 54, based on the unit length information 72 included in the inspection support information 74.

Next, the object generation unit 48 acquires the second three-dimensional coordinates, which are separated from the first three-dimensional coordinates in a direction from the start point to the end point of the object 54 by the virtual space distance, based on the plurality of pixels in the three-dimensional image 52 included in the inspection support information 74.

Next, the object generation unit 48 generates the object 54, which is an image including a FIG. 58 extending between the first three-dimensional coordinates and the second three-dimensional coordinates, and a numerical value 60 based on the length of the object 54. As an example, the object 54 shown in FIG. 11 is the same as the object 54 shown in FIG. 10.

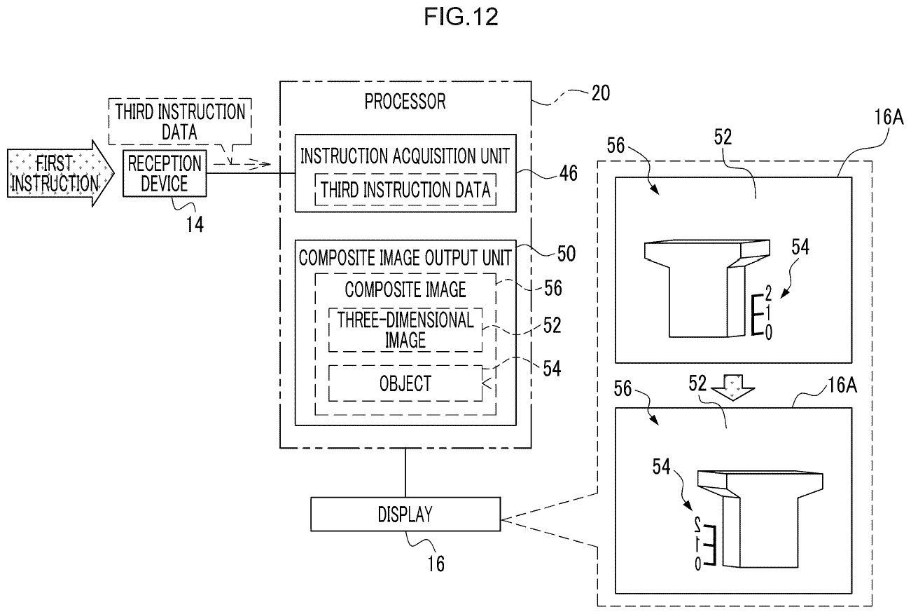

As an example, FIG. 12 shows a case in which an instruction (hereinafter, referred to as a “first instruction”) to change a viewpoint (hereinafter, referred to as a “first viewpoint”) for observing the three-dimensional image 52 through the screen 16A is received by the reception device 14 in a state in which the composite image 56 including the three-dimensional image 52 and the object 54 is displayed on the screen 16A. In this case, the instruction data (hereinafter, referred to as “third instruction data”) including the first instruction is output from the reception device 14 to the processor 20.

Examples of the first instruction include an instruction by clicking the mouse and an instruction by dragging the mouse.

The composite image output unit 50 changes the first viewpoint in response to the first instruction indicated by the third instruction data. The first viewpoint is an example of a “first viewpoint” according to the technology of the present disclosure. In addition, the composite image output unit 50 changes a viewpoint (hereinafter, referred to as a “second viewpoint”) for observing the object 54 through the screen 16A according to the first viewpoint. Consequently, the orientation of the three-dimensional image 52 and the object 54 is changed in the composite image 56.

It should be noted that, even in a case in which the FIG. 58 is reversed by changing the first viewpoint, the numerical value 60 may be maintained in a state of facing a front surface of the screen 16A. The second viewpoint is an example of a “second viewpoint” according to the technology of the present disclosure.

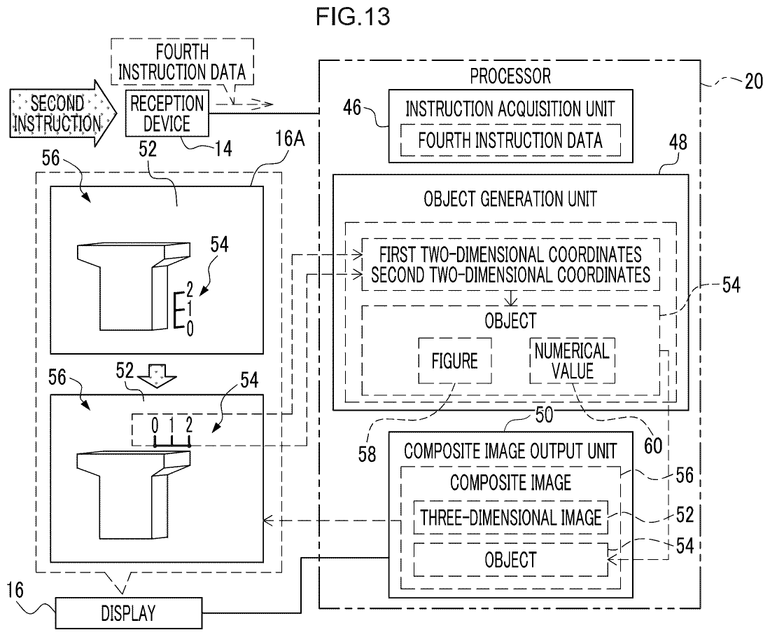

As an example, FIG. 13 shows a case in which an instruction (hereinafter, referred to as a “second instruction”) to change a viewpoint (hereinafter, referred to as a “third viewpoint”) for observing the object 54 through the screen 16A is received by the reception device 14 in a state in which the composite image 56 including the three-dimensional image 52 and the object 54 is displayed on the screen 16A. In this case, the instruction data (hereinafter, referred to as “fourth instruction data”) including the second instruction is output from the reception device 14 to the processor 20.

Examples of the second instruction include an instruction by clicking the mouse and an instruction by dragging the mouse. The second instruction is an example of a “second instruction” according to the technology of the present disclosure. The third viewpoint is an example of a “third viewpoint” according to the technology of the present disclosure.

In a case in which the fourth instruction data is acquired by the instruction acquisition unit 46, the object generation unit 48 acquires the first two-dimensional coordinates corresponding to the start point of the object 54 and the second two-dimensional coordinates corresponding to the end point in a case in which it is assumed that the third viewpoint is changed, based on the plurality of pixels in the screen 16A on which the three-dimensional image 52 is rendered.

Next, the object generation unit 48 generates a new object 54 via the same processing as the first object generation processing based on the first two-dimensional coordinates and the second two-dimensional coordinates.

The composite image output unit 50 generates the composite image 56 by combining the three-dimensional image 52 with the object 54 generated by the object generation unit 48. The composite image output unit 50 renders the composite image 56 on the screen 16A. Consequently, a new composite image 56 is displayed on the screen 16A of the display 16. In the new composite image 56, the third viewpoint is changed, and thus the orientation of the object 54 is changed.

It should be noted that the example shown in FIG. 13 shows a case in which the second instruction to change the third viewpoint is received by the reception device 14 in a state in which the composite image 56 is displayed on the screen 16A. However, even in a case in which the reception device 14 receives an instruction to move the object 54 or to change the length of the object 54 or the like in a state in which the composite image 56 is displayed on the screen 16A, the object generation unit 48 may acquire the first two-dimensional coordinates corresponding to the start point of the object 54 after the change and the second two-dimensional coordinates corresponding to the end point of the object 54 after the change. Then, the object generation unit 48 may generate the new object 54 based on the acquired first two-dimensional coordinates and the acquired second two-dimensional coordinates.

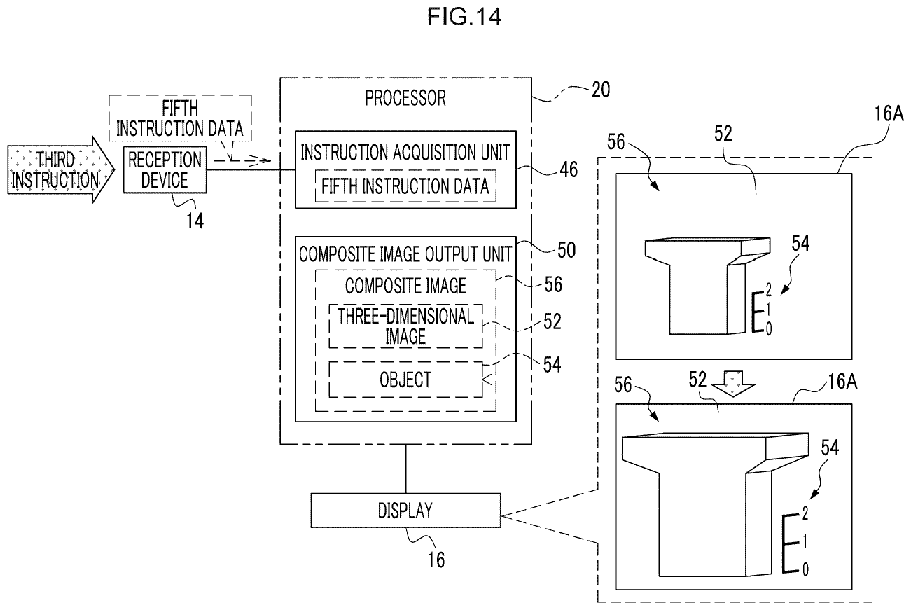

As an example, FIG. 14 shows a case in which an instruction (hereinafter, referred to as a “third instruction”) to change a size of the three-dimensional image 52 is received by the reception device 14 in a state in which the composite image 56 including the three-dimensional image 52 and the object 54 is displayed on the screen 16A. In this case, the instruction data (hereinafter, referred to as “fifth instruction data”) including the third instruction is output from the reception device 14 to the processor 20.

Examples of the third instruction include an instruction by clicking the mouse and an instruction by scrolling the screen 16A with a wheel provided in the mouse.

The composite image output unit 50 enlarges or reduces the composite image 56 including the three-dimensional image 52 and the object 54 in response to the third instruction indicated by the fifth instruction data. FIG. 14 shows an example in which the composite image 56 is enlarged as an example.

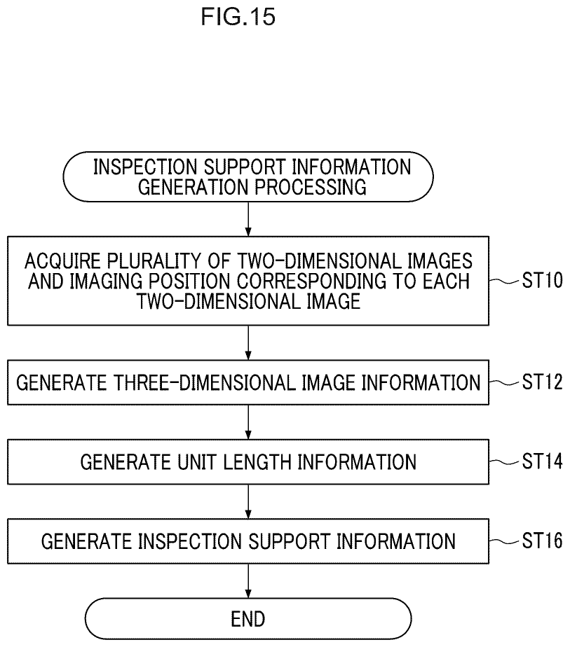

Next, an action of the inspection support apparatus 10 will be described with reference to FIGS. 15 to 18.

First, an example of a flow of the inspection support information generation processing performed by the processor 20 of the inspection support apparatus 10 will be described with reference to FIG. 15.

In the inspection support information generation processing shown in FIG. 15, first, in step ST10, the acquisition unit 32 (see FIG. 6) acquires the two-dimensional image 51 based on each image data received by the inspection support apparatus 10. In addition, the acquisition unit 32 acquires the imaging position corresponding to each two-dimensional image 51 based on each position data received by the inspection support apparatus 10. After the processing of step ST10 is executed, the inspection support information generation processing proceeds to step ST12.

In step ST12, the three-dimensional image information generation unit 34 (see FIG. 6) generates the three-dimensional image information 70 indicating the three-dimensional image 52 defined by the three-dimensional coordinate system based on the plurality of two-dimensional images 51 and the plurality of imaging positions which are acquired in step ST10. After the processing of step ST12 is executed, the inspection support information generation processing proceeds to step ST14.

In step ST14, the unit length information generation unit 36 (see FIG. 6) generates the unit length information 72 indicating the relationship between the first unit length and the second unit length. After the processing of step ST14 is executed, the inspection support information generation processing proceeds to step ST16.

In step ST16, the inspection support information generation unit 38 (see FIG. 7) generates the inspection support information 74 including the three-dimensional image information 70 generated by the three-dimensional image information generation unit 34, and the unit length information 72 generated by the unit length information generation unit 36. After the processing of step ST16 is executed, the inspection support information generation processing ends.

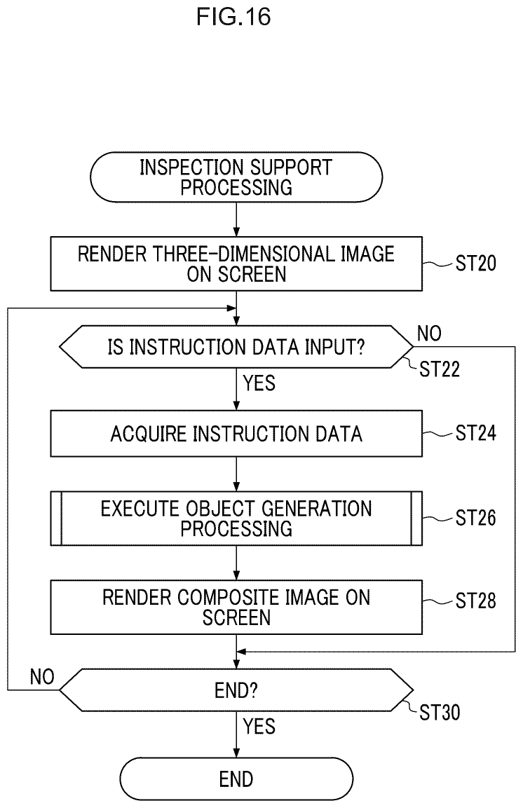

Next, an example of a flow of the inspection support processing performed by the processor 20 of the inspection support apparatus 10 will be described with reference to FIGS. 16 to 18. First, an example of an overall flow of the inspection support processing will be described with reference to FIG. 16.

In the inspection support processing shown in FIG. 16, first, in step ST20, the rendering unit 42 (see FIG. 9) renders the three-dimensional image 52 on the screen 16A based on the plurality of pixels in the three-dimensional image 52 included in the inspection support information 74. After the processing of step ST20 is executed, the inspection support processing proceeds to step ST22.

In step ST22, the instruction determination unit 44 (see FIG. 9) determines whether the instruction data is input to the processor 20. In step ST22, in a case in which the instruction data is input to the processor 20, an affirmative determination is made, and the inspection support processing proceeds to step ST24. In step ST22, in a case in which the instruction data is not input to the processor 20, a negative determination is made, and the inspection support processing proceeds to step ST30.

In step ST24, the instruction acquisition unit 46 (see FIG. 9) acquires the instruction data input to the processor 20. After the processing of step ST24 is executed, the inspection support processing proceeds to step ST26.

In step ST26, the object generation unit 48 executes the object generation processing for generating the object 54 based on the instruction data acquired in step ST24. After the processing of step ST26 is executed, the inspection support processing proceeds to step ST28.

In step ST28, the composite image output unit 50 generates the composite image 56 by combining the three-dimensional image 52 with the object 54 generated by the object generation unit 48. The composite image output unit 50 renders the composite image 56 on the screen 16A. Consequently, the composite image 56 in which the object 54 and the three-dimensional image 52 are shown in a comparable manner is displayed on the screen 16A of the display 16. After the processing of step ST28 is executed, the inspection support processing proceeds to step ST30.

In step ST30, the processor 20 determines whether a condition for ending the inspection support processing (hereinafter, referred to as an “end condition”) is met. Examples of the end condition include a condition in which an end instruction from the inspector 6 is received by the reception device 14, and an end instruction signal from the reception device 14 is input to the processor 20. In step ST30, in a case in which the end condition is not met, a negative determination is made, and the inspection support processing proceeds to step ST22. In step ST30, in a case in which the end condition is met, an affirmative determination is made, and the inspection support processing ends.

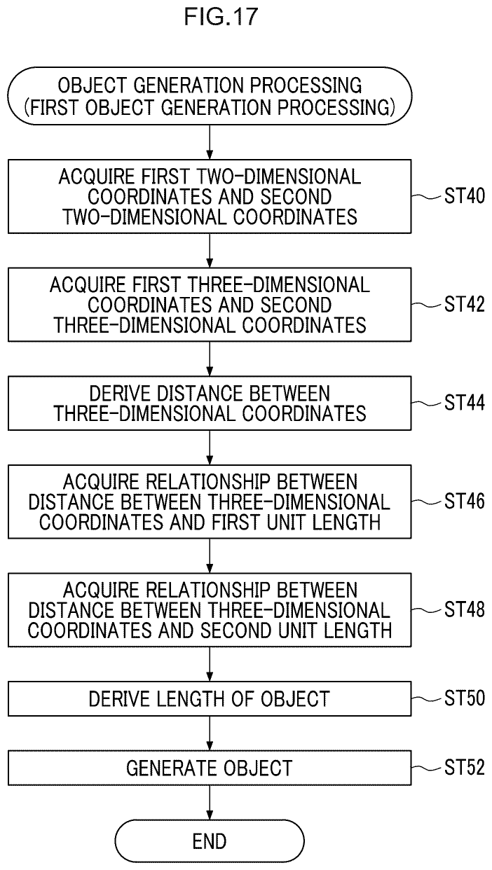

Next, a flow of the first object generation processing in the object generation processing executed in step ST26 will be described with reference to FIG. 17.

In the first object generation processing shown in FIG. 17, first, in step ST40, the object generation unit 48 (see FIG. 10) acquires the first two-dimensional coordinates corresponding to the start point of the object 54, and the second two-dimensional coordinates corresponding to the end point of the object 54, based on the plurality of pixels in the screen 16A on which the three-dimensional image 52 is rendered. After the processing of step ST40 is executed, the first object generation processing proceeds to step ST42.

In step ST42, the object generation unit 48 acquires the first three-dimensional coordinates corresponding to the first two-dimensional coordinates acquired in step ST40, and the second three-dimensional coordinates corresponding to the second two-dimensional coordinates acquired in step ST40, based on the plurality of pixels in the three-dimensional image 52 included in the inspection support information 74. After the processing of step ST42 is executed, the first object generation processing proceeds to step ST44.

In step ST44, the object generation unit 48 derives the distance between the three-dimensional coordinates between the first three-dimensional coordinates and the second three-dimensional coordinates, which are acquired in step ST42. After the processing of step ST44 is executed, the first object generation processing proceeds to step ST46.

In step ST46, the object generation unit 48 acquires the relationship between the distance between the three-dimensional coordinates derived in step ST44 and the first unit length, based on the unit length information 72 included in the inspection support information 74. After the processing of step ST46 is executed, the first object generation processing proceeds to step ST48.

In step ST48, the object generation unit 48 derives the relationship between the distance between the three-dimensional coordinates and the second unit length from the relationship between the distance between the three-dimensional coordinates derived in step ST46 and the first unit length, based on the unit length information 72 included in the inspection support information 74. After the processing of step ST48 is executed, the first object generation processing proceeds to step ST50.

In step ST50, the object generation unit 48 derives the length of the object 54 in a case in which it is assumed that the object 54 is disposed in the real space, based on the relationship between the distance between the three-dimensional coordinates and the second unit length, the relationship being derived in step ST48. After the processing of step ST50 is executed, the first object generation processing proceeds to step ST52.

In step ST52, the object generation unit 48 generates the object 54, which is the image including the FIG. 58 extending between the first three-dimensional coordinates and the second three-dimensional coordinates, and the numerical value 60 based on the length of the object 54. After the processing of step ST52 is executed, the first object generation processing ends.

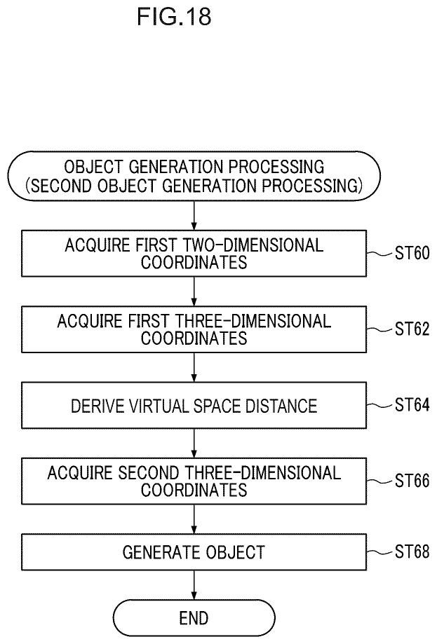

Next, a flow of the second object generation processing in the object generation processing executed in step ST26 will be described with reference to FIG. 18.

In the second object generation processing shown in FIG. 18, first, in step ST60, the object generation unit 48 (see FIG. 11) acquires the first two-dimensional coordinates corresponding to the start point of the object 54, based on the plurality of pixels in the screen 16A on which the three-dimensional image 52 is rendered. After the processing of step ST60 is executed, the second object generation processing proceeds to step ST62.

In step ST62, the object generation unit 48 acquires the first three-dimensional coordinates corresponding to the first two-dimensional coordinates acquired in step ST60, based on the plurality of pixels in the three-dimensional image 52 included in the inspection support information 74. After the processing of step ST62 is executed, the second object generation processing proceeds to step ST64.

In step ST64, the object generation unit 48 derives the virtual space distance in the three-dimensional virtual space 80 (see FIG. 6) corresponding to the direction from the start point to the end point of the object 54 and the length of the object 54, based on the unit length information 72 included in the inspection support information 74. After the processing of step ST64 is executed, the second object generation processing proceeds to step ST66.

In step ST66, the object generation unit 48 acquires the second three-dimensional coordinates, which are separated from the first three-dimensional coordinates acquired in step ST62 by the virtual space distance in the direction from the start point to the end point of the object 54, based on the plurality of pixels in the three-dimensional image 52 included in the inspection support information 74. After the processing of step ST66 is executed, the second object generation processing proceeds to step ST68.

In step ST68, the object generation unit 48 generates the object 54, which is the image including the FIG. 58 extending between the first three-dimensional coordinates and the second three-dimensional coordinates, and the numerical value 60 based on the length of the object 54. After the processing of step ST68 is executed, the second object generation processing ends.

It should be noted that the inspection support method described as the action of the inspection support apparatus 10 is an example of an “image processing method” according to the technology of the present disclosure.

As described in detail above, in the inspection support apparatus 10 according to the present embodiment, the processor 20 acquires the plurality of three-dimensional coordinates for specifying the positions of the plurality of pixels included in the three-dimensional image 52 showing the target object 4 in the real space, and the plurality of two-dimensional coordinates for specifying the positions corresponding to the plurality of pixels in the screen 16A on which the three-dimensional image 52 is rendered. In addition, the processor 20 acquires the unit length information 72 indicating the relationship between the first unit length of the three-dimensional coordinate system defining the three-dimensional coordinates, and the second unit length in the real space. Then, the processor 20 generates the object 54 of which the second unit length is specifiable, based on the plurality of three-dimensional coordinates, the plurality of two-dimensional coordinates, and the unit length information 72, and outputs the composite image 56 in which the generated object 54 and the three-dimensional image 52 are shown in a comparable manner. Therefore, a user and the like can visually compare the object 54 of which the unit length in the real space is specifiable and the three-dimensional image 52 through the composite image 56. Consequently, the user (for example, the inspector 6) can understand the size of the target object 4 in the real space.

In addition, the three-dimensional image 52 is the image generated based on the plurality of two-dimensional images 51 obtained by imaging the target object 4 from the plurality of imaging positions in the real space. Therefore, the target object 4 can be represented by the three-dimensional image 52.

In addition, the unit length information 72 is the information generated based on the distance between the imaging positions adjacent to each other among the plurality of imaging positions. Therefore, the first unit length can be derived, for example, based on the principle of three-dimensional measurement.

The distance between the imaging positions adjacent to each other is the distance obtained by the positioning unit 106. Therefore, for example, the distance between the imaging positions adjacent to each other can be measured quickly and accurately as compared with a case in which the distance is manually measured.

In addition, the object 54 is the image generated based on the designated two-dimensional coordinates among the plurality of two-dimensional coordinates. Therefore, the object 54 can be disposed at the designated position in the screen 16A by designating the two-dimensional coordinates through the screen 16A.

In addition, the object 54 is the image including the FIG. 58 and the numerical value 60 indicating the length related to the FIG. 58. Therefore, the user and the like can visually compare the target object 4, the FIG. 58, and the numerical value 60 with each other through the composite image 56.

The processor 20 changes the first viewpoint for observing the three-dimensional image 52 through the screen 16A in response to the given first instruction, and changes the second viewpoint for observing the object 54 through the screen 16A according to the first viewpoint. Therefore, even in a case in which the orientation of the three-dimensional image 52 is changed by changing the first viewpoint, it is possible to change the orientation of the object 54 according to the orientation of the three-dimensional image 52.

In addition, the processor 20 changes the third viewpoint for observing the object 54 through the screen 16A in response to the given second instruction. Therefore, it is possible to change the orientation of the object 54 independently of the three-dimensional image 52.

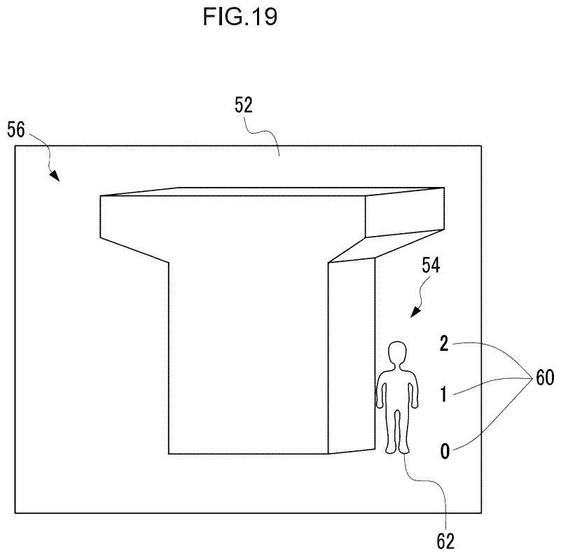

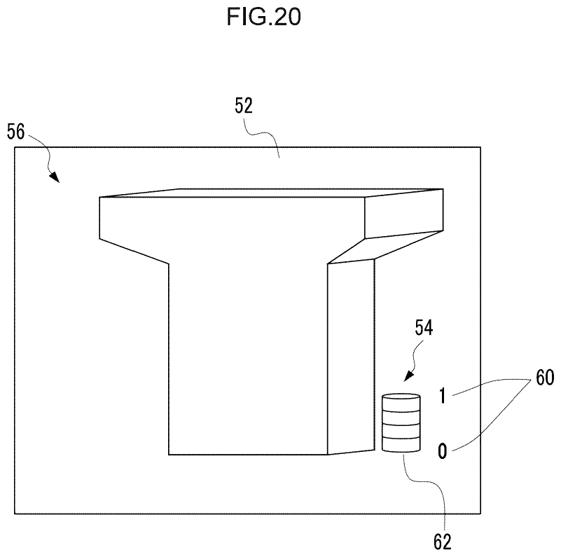

It should be noted that, in the embodiment described above, the object 54 includes the FIG. 58 resembling the ruler. However, as shown in FIGS. 19 and 20 as an example, the object 54 may include an image 62 showing a body existing in the real space instead of the FIG. 58 or in addition to the FIG. 58.

In the example shown in FIG. 19, the body shown by the image 62 is a human. In addition, in the example shown in FIG. 20, the body shown by the image 62 is a drum. It should be noted that the body shown by the image 62 may be any body such as a doll, an automobile, a bicycle, a motorcycle, a ladder, or an inspection tool.

In the examples shown in FIGS. 19 and 20, the object 54 includes the numerical value 60, but the numerical value 60 may be omitted in a case in which the image 62 is an image showing a body (for example, a human or the like) of which the size can be visually grasped in advance.

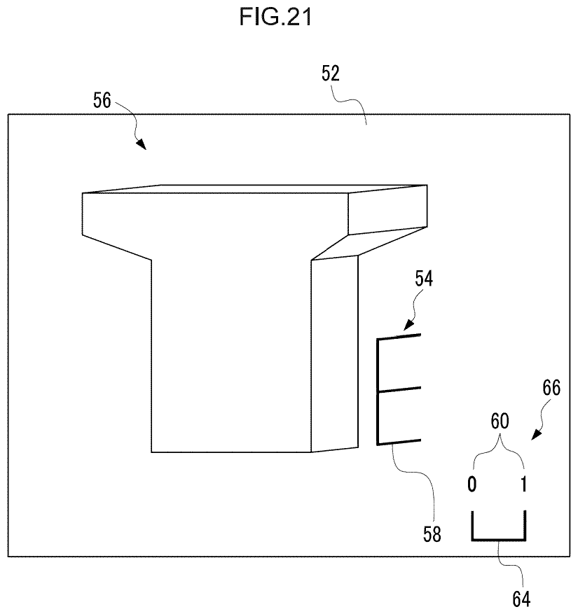

In addition, as shown in FIG. 21 as an example, the object 54 may include only the FIG. 58, and another object 66 including a numerical value 60 and a reference scale 64 may be displayed in a corner portion of the screen 16A.

In the embodiment described above, the unit length information generation unit 36 generates the unit length information 72 indicating the relationship between the first unit length and the second unit length, based on the relationship between the relative distance L1 defined by the coordinates of the three-dimensional coordinate system and the absolute distance L2 defined by the coordinates of the world coordinate system with respect to the distance between the imaging positions adjacent to each other (see FIG. 6). However, the unit length information 72 may be generated by, for example, the following processing.

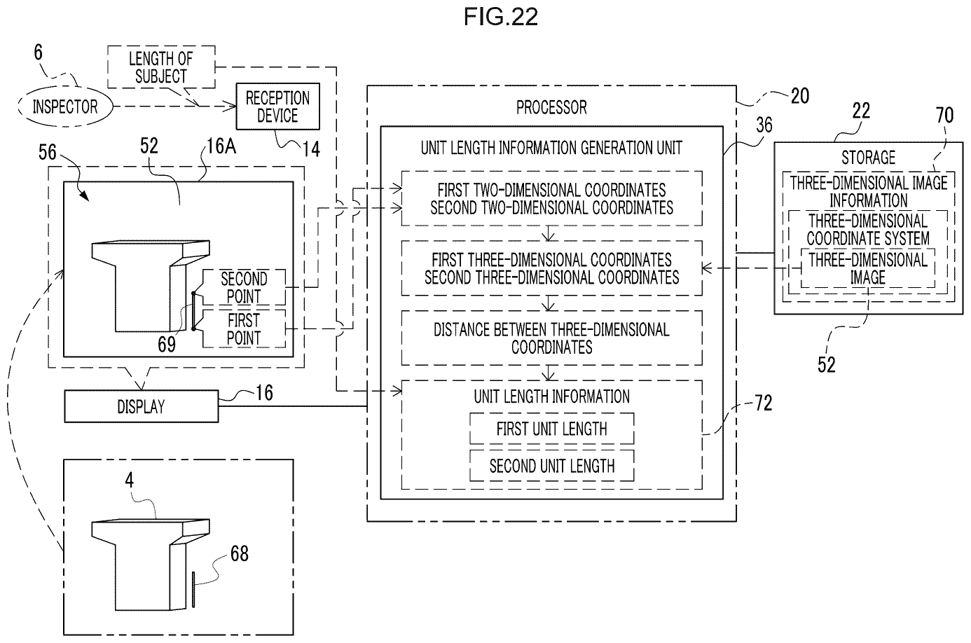

In the example shown in FIG. 22, a subject 68 is placed next to the target object 4 in the real space, and the three-dimensional image 52 includes a subject image 69 in which the subject 68 is shown as an image. In the example shown in FIG. 22, the subject 68 is a rod-like body, but the subject may be a body having a shape other than the rod-like shape. In addition, the subject image 69 need only be included in at least one two-dimensional image 51 among the plurality of two-dimensional images 51 (see FIG. 6) used to generate the three-dimensional image 52.

A length of the subject 68 (length corresponding to the distance between a first point and a second point of the subject image 69) is a known length, and is a length represented by the second unit length set in the real space. The length of the subject 68 is designated by the inspector 6, is received by the reception device 14, and is output to the processor 20 by the reception device 14.

The unit length information generation unit 36 acquires the first two-dimensional coordinates corresponding to the first point of the subject image 69 and the second two-dimensional coordinates corresponding to the second point of the subject image 69, based on the plurality of pixels in the screen 16A on which the three-dimensional image 52 is rendered. The first point and the second point of the subject image 69 are specified based on, for example, the instruction from the inspector 6 received by the reception device 14.

Next, the unit length information generation unit 36 acquires the first three-dimensional coordinates corresponding to the first two-dimensional coordinates and the second three-dimensional coordinates corresponding to the second two-dimensional coordinates based on the plurality of pixels in the three-dimensional image 52 included in the three-dimensional image information 70.

Then, the unit length information generation unit 36 derives the distance between the three-dimensional coordinates between the first three-dimensional coordinates and the second three-dimensional coordinates. The distance between the three-dimensional coordinates is the distance represented by the first unit length set in the three-dimensional coordinate system.

Next, the unit length information generation unit 36 generates the unit length information 72 indicating the relationship between the first unit length and the second unit length, based on the relationship between the length of the subject 68 designated by the inspector 6 and the distance between the three-dimensional coordinates.

In the example shown in FIG. 22, the second unit length is a length related to the subject image 69 included in at least one two-dimensional image 51 among the plurality of two-dimensional images 51 (see FIG. 6). Therefore, for example, even in a case in which the positioning unit 106 is not mounted in the imaging apparatus 100 (see FIG. 3), the unit length information 72 can be generated.

It should be noted that, in the example shown in FIG. 22, the subject 68 is placed next to the target object 4, but the subject 68 may be, for example, a mark (for example, a mark drawn with chalk) drawn on a wall surface of the target object 4.

Further, the processor 20 is shown in the embodiment described above, but at least one CPU, at least one GPU, and/or at least one TPU may be used instead of the processor 20 or together with the processor 20.

In addition, in the embodiment described above, the form example is described in which the inspection support information generation program 30 and the inspection support program 40 are stored in the storage 22, but the technology of the present disclosure is not limited to this. The inspection support information generation program 30 and/or the inspection support program 40 may be stored in, for example, a portable non-transitory computer-readable storage medium, such as an SSD or a USB memory (hereinafter, simply referred to as a “non-transitory storage medium”). The inspection support information generation program 30 and/or the inspection support program 40 stored in the non-transitory storage medium may be installed in the computer 12 of the inspection support apparatus 10.

In addition, the inspection support information generation program 30 and/or the inspection support program 40 may be stored in a storage device of another computer, a server device, or the like connected to the inspection support apparatus 10 via a network, and the inspection support information generation program 30 and/or the inspection support program 40 may be downloaded in response to a request of the inspection support apparatus 10 and installed in the computer 12.

In addition, it is not necessary to store all of the inspection support information generation program 30 and/or the inspection support program 40 in the storage device of the other computer or in the server device connected to the inspection support apparatus 10 or in the storage 22, and a part of the inspection support information generation program 30 and/or the inspection support program 40 may be stored.

In addition, although the computer 12 is built in the inspection support apparatus 10, the technology of the present disclosure is not limited to this, and, for example, the computer 12 may be provided outside the inspection support apparatus 10.

In addition, in the embodiment described above, although the computer 12 including the processor 20, the storage 22, and the RAM 24 is shown, the technology of the present disclosure is not limited to this, and a device including an ASIC, an FPGA, and/or a PLD may be applied instead of the computer 12. Also, a combination of a hardware configuration and a software configuration may be used instead of the computer 12.

Further, the following various processors can be used as a hardware resource for executing the various types of processing described in the embodiment described above. Examples of the processor include a CPU which is a general-purpose processor functioning as the hardware resource for executing the various types of processing by executing software, that is, a program. Moreover, examples of the processor include a dedicated electronic circuit which is a processor having a circuit configuration designed to be dedicated for executing specific processing, such as the FPGA, the PLD, or the ASIC. Any processor includes a memory built therein or connected thereto, and any processor uses the memory to execute various types of processing.

The hardware resource for executing various types of processing may be configured by one of the various processors or may be configured by a combination of two or more processors that are the same type or different types (for example, combination of a plurality of FPGAs or combination of a CPU and an FPGA). Further, the hardware resource for executing the various types of processing may be one processor.

As a configuration example of one processor, first, there is a form in which one processor is configured by a combination of one or more CPUs and software and the processor functions as the hardware resource for executing the various types of processing. Secondly, as represented by an SoC, there is a form in which a processor that implements the functions of the entire system including a plurality of hardware resources for executing various types of processing with one IC chip is used. As described above, the various types of processing are implemented by using one or more of the various processors as the hardware resource.

Further, specifically, an electronic circuit obtained by combining circuit elements, such as semiconductor elements, can be used as the hardware structure of the various processors. In addition, the processing described above is merely an example. Accordingly, it goes without saying that unnecessary steps may be deleted, new steps may be added, or the processing order may be changed within a range that does not deviate from the gist.

The contents described and shown above are detailed descriptions of portions related to the technology of the present disclosure and are merely examples of the technology of the present disclosure. For example, the descriptions of the configurations, functions, operations, and effects are the descriptions of examples of the configurations, functions, operations, and effects of the portions related to the technology of the present disclosure. Therefore, it goes without saying that unnecessary portions may be deleted or new elements may be added or replaced in the contents described and shown above, without departing from the gist of the technology of the present disclosure. In addition, the description of, for example, common technical knowledge that does not need to be particularly described to enable the implementation of the technology of the present disclosure is omitted in the contents described and shown above in order to avoid confusion and to facilitate the understanding of the portions related to the technology of the present disclosure.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All of the documents, the patent applications, and the technical standards described in the specification are incorporated by reference herein to the same extent as each individual document, each patent application, and each technical standard is specifically and individually stated to be incorporated by reference.

What is claimed is:

1. An image processing apparatus comprising:
a processor,
wherein the processor is configured to:
acquire a plurality of three-dimensional coordinates for specifying positions of a plurality of pixels included in a three-dimensional image showing a target object in a real space, generated based on a plurality of two-dimensional images obtained by imaging the target object from a plurality of imaging positions in the real space at a plurality of viewpoints corresponding to the respective imaging positions, and a plurality of two-dimensional coordinates for specifying positions corresponding to the plurality of pixels in a screen on which the three-dimensional image is rendered;
acquire unit length information indicating a relationship between a first unit length of a three-dimensional coordinate system defining the three-dimensional coordinates, and a second unit length of the real space;
generate an object of which the second unit length is specifiable, based on the plurality of three-dimensional coordinates, the plurality of two-dimensional coordinates, and the unit length information; and
output a first image in which the object and the three-dimensional image are shown in a comparable manner.

2. The image processing apparatus according to claim 1,
wherein the three-dimensional image is an image generated based on a plurality of two-dimensional images obtained by imaging the target object from a plurality of imaging positions in the real space.

3. The image processing apparatus according to claim 2,
wherein the unit length information is information generated based on a distance between imaging positions adjacent to each other among the plurality of imaging positions.

4. The image processing apparatus according to claim 3,
wherein the distance is a distance obtained by a positioning unit.

5. The image processing apparatus according to claim 2,
wherein the second unit length is a length related to a subject image included in at least one two-dimensional image among the plurality of two-dimensional images.

6. The image processing apparatus according to claim 1,
wherein the object is an image generated based on designated two-dimensional coordinates among the plurality of two-dimensional coordinates.

7. The image processing apparatus according to claim 1,
wherein the object is an image including a figure and a numerical value indicating a length related to the figure.

8. The image processing apparatus according to claim 1,
wherein the processor is configured to:
change a first viewpoint for observing the three-dimensional image through the screen in response to a given first instruction; and
change a second viewpoint for observing the object through the screen according to the first viewpoint.

9. The image processing apparatus according to claim 1,
wherein the processor is configured to change a third viewpoint for observing the object through the screen in response to a given second instruction.

10. The image processing apparatus according to claim 1,
wherein the object includes an image showing a body existing in the real space.

11. An image processing method comprising:
acquiring a plurality of three-dimensional coordinates for specifying positions of a plurality of pixels included in a three-dimensional image showing a target object in a real space, generated based on a plurality of two-dimensional images obtained by imaging the target object from a plurality of imaging positions in the real space at a plurality of viewpoints corresponding to the respective imaging positions, and a plurality of two-dimensional coordinates for specifying positions corresponding to the plurality of pixels in a screen on which the three-dimensional image is rendered;
acquiring unit length information indicating a relationship between a first unit length of a three-dimensional coordinate system defining the three-dimensional coordinates, and a second unit length of the real space;
generating an object of which the second unit length is specifiable, based on the plurality of three-dimensional coordinates, the plurality of two-dimensional coordinates, and the unit length information; and
outputting a first image in which the object and the three-dimensional image are shown in a comparable manner.

12. A non-transitory computer-readable storage medium storing a program causing a computer to execute a process comprising:
acquiring a plurality of three-dimensional coordinates for specifying positions of a plurality of pixels included in a three-dimensional image showing a target object in a real space, generated based on a plurality of two-dimensional images obtained by imaging the target object from a plurality of imaging positions in the real space at a plurality of viewpoints corresponding to the respective imaging positions, and a plurality of two-dimensional coordinates for specifying positions corresponding to the plurality of pixels in a screen on which the three-dimensional image is rendered;
acquiring unit length information indicating a relationship between a first unit length of a three-dimensional coordinate system defining the three-dimensional coordinates, and a second unit length of the real space;
generating an object of which the second unit length is specifiable, based on the plurality of three-dimensional coordinates, the plurality of two-dimensional coordinates, and the unit length information; and
outputting a first image in which the object and the three-dimensional image are shown in a comparable manner.
